(19) United States
(12) Patent Application Publication
(10) Pub. No.: US 2026/0274278 A1
(43) Pub. Date: Sep. 17, 2026

(54) UPDATE SYSTEM, ONBOARD APPARATUS, AND SERVER

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shogo KAMIGUCHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/163,179

(22) PCT Filed: Feb. 26, 2024
(86) PCT No.: PCT/JP2024/006820

§ 371 Date: Sep. 8, 2025

(30) Foreign Application Priority Data
Mar. 9, 2023 (JP) 2023-036466

(51) Int. Cl. B60W 50/06; H04L 9/40; H04L 12/40

(52) U.S. Cl. CPC B60W 50/06; H04L 12/40032; H04L 63/1416; H04L 2012/40215; H04L 2012/40273

(57) ABSTRACT

An update system includes: an onboard apparatus and a server, the onboard apparatus including: a first trained model receiving a first vehicle value transmitted over an onboard network, and output an estimated value correlated with the first vehicle value, and a first determination unit configured to compare the estimated value output from the first trained model with a second vehicle value, and determine whether or not the first trained model is compatible with a vehicle, the server including: a selection unit configured to select a second trained model for updating the first trained model if the first trained model is not compatible with the vehicle. A transmission unit transmits the selected second trained model to the onboard apparatus. The onboard apparatus includes a receiving unit configured to receive the second trained model, and an update unit, configured to update the first trained model to the second trained model.

### CROSS-REFERENCE TO RELATED APPLICATIONS

This application is the U.S. national stage of PCT/JP2024/006820 filed on Feb. 26, 2024, which claims priority of Japanese Patent Application No. JP 2023-036466 filed on Mar. 9, 2023, the contents of which are incorporated herein.

### TECHNICAL FIELD

The present disclosure relates to an update system, an onboard apparatus, and a server.

### BACKGROUND

Various types of onboard apparatuses, such as control ECUs (Electronic Control Units) that control engines, transmissions, etc., body ECUs that control headlights, power windows, etc., and information ECUs for navigation apparatuses, multimedia devices, etc., are mounted in vehicles. Onboard apparatuses in a vehicle are connected to an onboard network and can communicate with each other.

There is a problem in that an illegitimate onboard apparatus is connected to an onboard network by masquerading as a legitimate onboard apparatus and transmits an unauthorized frame to the onboard network, resulting in unauthorized control of the vehicle. For this reason, techniques for detecting unauthorized frames in an onboard network have been proposed (for example, WO2020/203352, WO2019/116973, and JP 2020-96286).

When performing processing for detecting an unauthorized frame using a trained model generated through machine learning, an unauthorized frame cannot be accurately detected if the relationship between an input value and an output value of the trained model changes due to deterioration of the vehicle over time or the like. WO2019/116973 discloses an apparatus that retrains a trained model when the relationship between a first vehicle value and a second vehicle value obtained from sensors mounted in a vehicle changes due to deterioration of an onboard device.

However, there is a problem with the apparatus disclosed in WO2019/116973 in that a waiting time is long since it is necessary to record, as logs, first and second vehicle values obtained from sensors in order to retrain a trained model.

### SUMMARY

An update system according to one aspect of the present disclosure includes: an onboard apparatus and a server, the onboard apparatus including: a first trained model configured to receive, as input data, a first vehicle value transmitted over an onboard network to which the onboard apparatus is to be connected, and output an estimated value correlated with the first vehicle value, and a first determination unit configured to compare the estimated value output from the first trained model with a second vehicle value transmitted over the onboard network, and determine whether or not the first trained model is compatible with a vehicle, the server including: a selection unit configured to select a second trained model for updating the first trained model if the first determination unit determines that the first trained model is not compatible with the vehicle, and a transmission unit configured to transmit the second trained model selected by the selection unit to the onboard apparatus, and the onboard apparatus including: a receiving unit configured to receive the second trained model transmitted from the server, and an update unit configured to update the first trained model to the second trained model received by the receiving unit.

### ADVANTAGEOUS EFFECTS OF THE PRESENT DISCLOSURE

According to the present disclosure, it is possible to update a trained model within a short period of time.

### BRIEF DESCRIPTION OF DRAWINGS

FIG. 1 is a block diagram showing an example of the configuration of an update system according to an embodiment of the present disclosure.

FIG. 2 is a block diagram showing an example of the hardware configuration of a relay ECU according to the embodiment.

FIG. 3 is a block diagram showing an example of the hardware configuration of a server according to the embodiment.

FIG. 4 is a schematic diagram showing an example of the configuration of a trained model according to the embodiment.

FIG. 5 is a diagram showing an example of the configuration of a trained model DB.

FIG. 6 is a functional block diagram showing exemplary functions of the relay ECU according to the embodiment.

FIG. 7 is a functional block diagram showing exemplary functions of the server according to the embodiment.

FIG. 8 is a flowchart showing exemplary operations of the relay ECU according to the embodiment.

FIG. 9 is a flowchart showing an example of unauthorized frame detection processing.

FIG. 10A shows a first part of a flowchart showing an example of update processing.

FIG. 10B shows a second part of the flowchart showing the example of update processing.

FIG. 11 is a flowchart showing exemplary operations of the server according to the embodiment.

FIG. 12 is a flowchart showing an example of model selection processing.

FIG. 13 is a sequence diagram showing exemplary operations of the update system according to the embodiment.

### DETAILED DESCRIPTION OF PREFERRED EMBODIMENTS

Embodiments of the present disclosure will be listed and described below.

In a first aspect, an updating system according to the present embodiment includes: an onboard apparatus and a server, the onboard apparatus including: a first trained model configured to receive, as input data, a first vehicle value transmitted over an onboard network to which the onboard apparatus is to be connected, and output an estimated value correlated with the first vehicle value, and a first determination unit configured to compare the estimated value output from the first trained model with a second vehicle value transmitted over the onboard network, and determine whether or not the first trained model is compatible with a vehicle, the server including: a selection unit configured to select a second trained model for updating the first trained model if the first determination unit determines that the first trained model is not compatible with the vehicle, and a transmission unit configured to transmit the second trained model selected by the selection unit to the onboard apparatus, and the onboard apparatus including: a receiving unit configured to receive the second trained model transmitted from the server, and an update unit configured to update the first trained model to the second trained model received by the receiving unit. Accordingly, there is no need to perform retraining in the onboard apparatus, and it is possible to update a trained model within a short period of time.

In a second aspect according to the first aspect, the onboard apparatus may further include a storage unit configured to store first and second vehicle values previously transmitted over the onboard network, and the first determination unit may compare the estimated value output from the first trained model as a result of inputting the first vehicle value stored in the storage unit to the first trained model, with the second vehicle value stored in the storage unit, and determine whether or not the first trained model is compatible with the vehicle. Accordingly, by using the first and second vehicle values, which are actual values stored in the storage unit, it is possible to accurately determine whether or not the first trained model is compatible with the vehicle.

In a third aspect according to the second aspect, the first determination unit may determine whether or not the first trained model is compatible with the vehicle while the vehicle is in a stopped state. Accordingly, it is possible to execute determination as to whether or not the first trained model is compatible with the vehicle while the vehicle is stopped and travelling control is not required.

In a fourth aspect according to the second or the third aspect, the onboard apparatus may further include a mode setting unit configured to set an operation mode to either a normal mode in which the vehicle travels or a maintenance mode for performing maintenance on the vehicle, and the first determination unit may determine whether or not the first trained model is compatible with the vehicle when the operation mode is the maintenance mode. Accordingly, while the operation mode is set to the maintenance mode, it is possible to execute determination as to whether or not the first trained model is compatible with the vehicle.

In a fifth aspect according to the fourth aspect, the onboard apparatus may further include a second determination unit configured to, when the operation mode is the normal mode, compare the estimated value output from the first trained model with a second vehicle value transmitted over the onboard network, and determine whether or not a frame that includes the second vehicle value is an unauthorized frame. Accordingly, it is possible to perform processing for detecting an unauthorized frame using the first trained model while the operation mode is the normal mode.

In a sixth aspect according to any one of the first to the fifth aspects, the selection unit may select the second trained model based on vehicle information related to the vehicle. Accordingly, a second trained model corresponding to the vehicle can be provided to the onboard apparatus.

In a seventh aspect according to the sixth aspect, the vehicle information may include a vehicle type of the vehicle. Accordingly, a second trained model corresponding to the vehicle type of the vehicle can be provided to the onboard apparatus.

In an eighth aspect according to the sixth or the seventh aspect, the vehicle information may include a model year of the vehicle. Accordingly, a second trained model corresponding to the model year of the vehicle can be provided to the onboard apparatus.

In a ninth aspect according to any one of the sixth to the eight aspects, the vehicle information may include a total mileage of the vehicle. Accordingly, a second trained model corresponding to the total mileage of the vehicle can be provided to the onboard apparatus.

In a tenth aspect according to the sixth aspect, the vehicle information may include a vehicle type, a model year, and a total mileage of the vehicle, the selection unit may select the second trained model corresponding to the vehicle type and the model year included in the vehicle information, and, when a plurality of second trained models corresponding to the vehicle type and the model year included in the vehicle information are present, the selection unit may select one of the plurality of second trained models based on the total mileage included in the vehicle information. Accordingly, it is possible to select a second trained model corresponding to the vehicle type and the model year of the vehicle. Furthermore, when there are a plurality of second trained models corresponding to the vehicle type and the model year of the vehicle, it is possible to select an appropriate second trained model based on the total mileage.

In an eleventh aspect according to any one of the first to the tenth aspects, the selection unit may select the second trained model from a storage unit that stores a plurality of trained models. Accordingly, it is possible to select a trained model compatible with the vehicle from various trained models, as a second trained model.

In a twelfth aspect according to any one of the first to the eleventh aspects, the onboard apparatus may further include: a third determination unit configured to compare an estimated value output from the second trained model with a second vehicle value transmitted over the onboard network, and determine whether or not the second trained model is compatible with the vehicle, and a training unit configured to generate a third trained model by executing supervised learning using the first and second vehicle values transmitted over the onboard network as training data if the third determination unit determines that the second trained model is not compatible with the vehicle, and the update unit may update the first trained model to the third trained model generated by the training unit. Accordingly, in a case where the second trained model provided from the server is not compatible with the vehicle, it is possible to generate a third trained model compatible with the vehicle, and update the first trained model to the third trained model.

In a thirteenth aspect according to the twelfth aspect, the onboard apparatus may further include a storage control unit configured to store the third trained model generated by the training unit, in a storage unit that stores a plurality of trained models usable for a plurality of vehicles. Accordingly, the generated third trained model can be used for another vehicle.

In a fourteenth aspect according to any one of the first to the thirteenth aspects, the onboard apparatus may be a relay apparatus that is to be connected to a plurality of communication lines included in the onboard network, and is configured to relay a frame between a plurality of onboard apparatuses. Accordingly, it is possible to update a learning model in the relay apparatus that relays a frame between a plurality of onboard apparatus.

In a fifteenth aspect, an onboard apparatus according to the present embodiment is an onboard apparatus to be connected to an onboard network, the onboard apparatus including: a first trained model configured to receive, as input data, a first vehicle value transmitted over the onboard network and output an estimated value correlated with the first vehicle value; a first determination unit configured to compare the estimated value output from the first trained model with a second vehicle value transmitted over the onboard network, and determine whether or not the first trained model is compatible with a vehicle; a receiving unit configured to receive a second trained model for updating the first trained model from a server if the first determination unit determines that the first trained model is not compatible with the vehicle; and an update unit configured to update the first trained model to the second trained model received by the receiving unit. Accordingly, there is no need to perform retraining in the onboard apparatus, and it is possible to update a trained model within a short period of time.

In a sixteenth aspect, a server according to the present embodiment is a server capable of communicating with an onboard apparatus, the server including: a selection unit configured to compare an estimated value output from a first trained model configured to receive, as input data, a first vehicle value transmitted over an onboard network to which the onboard apparatus is to be connected and output an estimated value corelated with the first vehicle value, with a second vehicle value transmitted over the onboard network, and select a second trained model for updating the first trained model, if the first trained model is determined to be not compatible with a vehicle; and, and a transmission unit configured to transmit the second trained model selected by the selection unit to the onboard apparatus. Accordingly, there is no need to perform retraining in the onboard apparatus, and it is possible to update a trained model within a short period of time.

The present disclosure can be realized not only as an update system having the above characteristic configurations, an onboard apparatus included in the update system, or a server included in the update system, but can also be realized as an update method for executing steps of characteristic processing in the onboard apparatus, and an update program for causing the onboard apparatus to execute the characteristic processing, and a portion or the entirety of the above relay apparatus can be realized as a semiconductor integrated circuit. Furthermore, the present disclosure can also be realized as a method for executing steps of characteristic processing in the server, and a program for causing the server to execute the characteristic processing, and a portion or the entirety of the server can be realized as a semiconductor integrated circuit.

Embodiments of the present disclosure will be described below in detail with reference to the drawings. Note that at least some of the embodiments described below may be suitably combined.

### 1. Update System

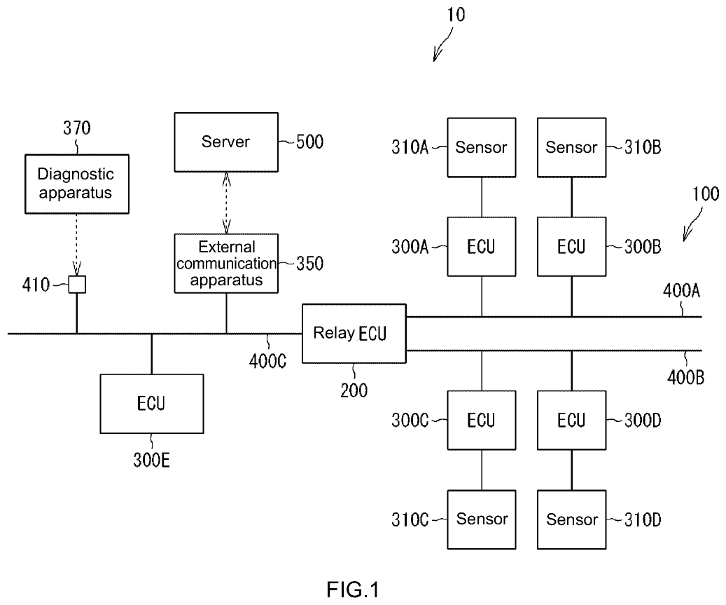

FIG. 1 is a block diagram showing an example of the configuration of an update system according to the present embodiment. An update system 10 includes a relay ECU 200 mounted in a vehicle and a server 500 provided outside the vehicle.

The vehicle includes an onboard system 100. The onboard system 100 includes the relay ECU 200 and ECUs 300A, 300B, 300C, 300D, and 300E. The onboard system 100 is an onboard network constituted by the relay ECU 200, the ECUs 300A, 300B, 300C, 300D, and 300E, and communication lines (communication buses) that connect them.

The plurality of ECUs 300A, 300B, 300C, 300D, and 300E are provided in various parts of the vehicle. The ECUs 300A, 300B, 300C, 300D, and 300E individually control hardware components of the parts of the vehicle, and monitor the states of the hardware components of the parts of the vehicle. For example, each of the ECUs 300A, 300B, 300C, 300D, and 300E is a control ECU, a body ECU, or an information ECU. Note that, in the following description, the ECUs 300A, 300B, 300C, and 300D are also collectively referred to as “ECUs 300”.

The ECUs 300A, 300B, 300C, and 300D are connected to sensors. The sensors detect physical amounts related to the vehicle. For example, a sensor 310A that detects the engine speed is connected to the ECU 300A. For example, a sensor 310B that detects the depression amount of the accelerator pedal, i.e., a throttle opening degree, is connected to the ECU 300B. For example, a sensor 310C that detects the gear position in the transmission mechanism mounted in the vehicle is connected to the ECU 300C. For example, a sensor 310D that detects the wheel rotation speed, i.e., a vehicle speed, is connected to the ECU 300D. The engine speed, throttle opening degree, gear position, and vehicle speed are examples of “vehicle values”.

The relay ECU 200 is connected to the ECUs 300A, 300B, 300C, 300D, and 300E via communication buses 400A, 400B, and 400C, which may be CAN (Controller Area Network) buses. Specifically, the ECUs 300A and 300B are connected to the bus 400A. The ECUs 300C and 300D are connected to the bus 400B. The ECU 300E is connected to the bus 400C. The relay ECU 200 can mutually communicate with each of the ECUs 300A, 300B, 300C, 300D, and 300E. The relay ECU 200 and the ECUs 300A, 300B, 300C, 300D, and 300E are examples of an “onboard apparatus”.

The relay ECU 200 and the ECUs 300 use a communication protocol for periodically or non-periodically transmitting and receiving messages. For example, CAN or CAN FD (CAN with Flexible Data Rate) is used as the communication protocol. In another example, Ethernet (registered trademark) is used as the communication protocol.

The relay ECU 200 functions as a gateway that relays communication between a plurality of ECUs 300. Each ECU 300 is capable of transmitting frames. Frames are messages conforming to the above communication protocol. The relay ECU 200 relays frames between ECUs connected to different buses. For example, the relay ECU 200 can relay frames between the ECU 300A connected to the bus 400A and the ECU 300C connected to the bus 400B.

The ECUs 300A, 300B, 300C, and 300D are capable of transmitting frames that include the above vehicle values. The ECUs 300A, 300B, 300C, 300D, and 300E that have received frames can obtain vehicle values from the received frames.

The relay ECU 200 is connected to an external communication apparatus 350 via the bus 400C. The external communication apparatus 350 is, for example, a TCU (Telematics Control Unit), and can communicate with an apparatus outside the vehicle. The external communication apparatus 350 includes a wireless communication interface for a mobile communication system such as the fifth-generation mobile communication system (5G) or the fourth-generation mobile communication system (4G). The external communication apparatus 350 can transmit and receive TCP/IP (Transmission Control Protocol/Internet Protocol) packets, for example. The external communication apparatus 350 is connected to a base station (not illustrated) of a mobile communication network, and can communicate with an apparatus connected to the Internet via the base station. Specifically, the external communication apparatus 350 can communicate with the server 500. The external communication apparatus 350 relays communication between the relay ECU 200 and the server 500.

A connector 410 is connected to the bus 400C. The connector 410 is, for example, a connector conforming to OBD1 (On-Board Diagnostics First Generation) or OBD2 (On-Board Diagnostics Second Generation). A diagnostic apparatus 370 for performing diagnosis of the vehicle can be connected to the connector 410. The diagnostic apparatus 370 can communicate with the relay ECU 200 and the ECUs 300 using the above communication protocol. For example, the diagnostic apparatus 370 can collect vehicle values detected by sensors, abnormalities or warning information previously detected by the ECUs 300, and the like, from the relay ECU 200 and the ECUs 300.

### 2. Hardware Configuration of Relay ECU

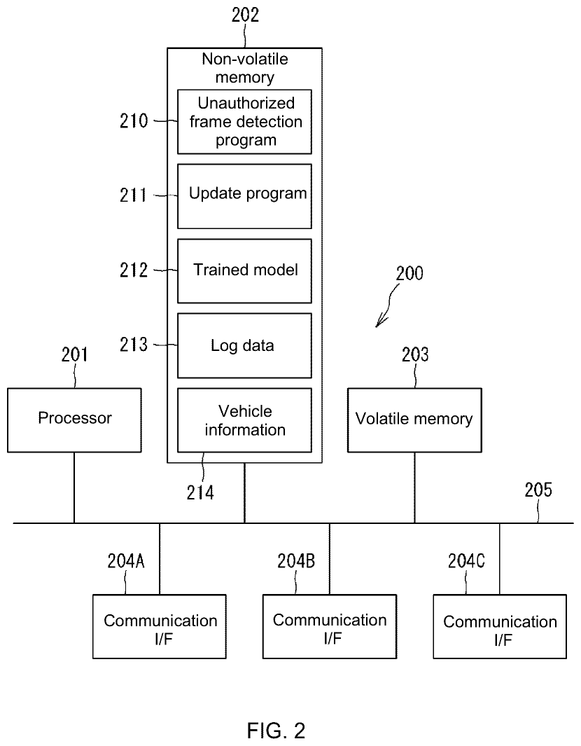

FIG. 2 is a block diagram showing an exemplary hardware configuration of a relay ECU according to the present embodiment. The relay ECU 200 includes a processor 201, a non-volatile memory 202, a volatile memory 203, and communication interfaces (hereinafter, also referred to as “communication I/Fs”) 204A, 204B, and 204C. The processor 201, the non-volatile memory 202, the volatile memory 203, and the communication I/Fs 204 are connected to each other by a bus 205 that is a communication line. The processor 201, the non-volatile memory 202, the volatile memory 203, and the communication I/Fs 204 can transmit data to each other via the bus 205. The relay ECU 200 is an example of a “relay apparatus”.

The volatile memory 203 is, for example, a semiconductor memory such as an SRAM (Static Random Access Memory) or a DRAM (Dynamic Random Access Memory). The non-volatile memory 202 is a flash memory, a hard disk, a ROM (Read Only Memory), or the like. The non-volatile memory 202 stores an unauthorized frame detection program 210 and an update program 211, which are computer programs, and data used for executing the unauthorized frame detection program 210 and the update program 211. The functions of the relay ECU 200 described later are performed by the processor 201 executing the unauthorized frame detection program 210 and the update program 211.

The processor 201 is, for example, a CPU (Central Processing Unit). Note that the processor 201 is not limited to a CPU. The processor 201 may be a GPU (Graphics Processing Unit). In a specific example, the processor 201 is a multi-core processor. The processor 201 may also be a single-core processor. The processor 201 is configured to be capable of executing a computer program. Note that the processor 201 may be, for example, an ASIC (Application Specific Integrated Circuit), or may be a programmable logic device such as an FPGA (Field Programmable Gate Array). In this case, the ASIC or programmable logic device is configured to be capable of executing the same functions as the unauthorized frame detection program 210 and the update program 211.

The communication I/Fs 204A, 204B, and 204C are communication interfaces conforming to the above communication protocol for an onboard network. The communication I/Fs 204A, 204B, and 204C are, for example, CAN interfaces. The communication I/Fs 204A, 204B, and 204C may also be Ethernet interfaces.

The communication I/F 204A is connected to the bus 400A. The communication I/F 204B is connected to the bus 400B. The communication I/F 204C is connected to the bus 400C. The relay ECU 200 can communicate with the ECUs 300A and 300B using the communication I/F 204A. The relay ECU 200 can communicate with the ECUs 300C and 300D using the communication I/F 204B. The relay ECU 200 can communicate with the ECU 300E using the communication I/F 204C. Furthermore, the relay ECU 200 can communicate with the diagnostic apparatus 370 using the communication I/F 204C, and can communicate with the server 500 via the external communication apparatus 350.

The non-volatile memory 202 stores a trained model 212 used for detecting unauthorized frames. The trained model 212 will be described later.

The non-volatile memory 202 stores log data 213. The log data 213 includes previously detected vehicle values, i.e., engine speeds, throttle opening degrees, gear positions, vehicle speeds, and the like.

The non-volatile memory 202 stores vehicle information 214. The vehicle information 214 includes the vehicle type, the model year, and the total mileage of the vehicle. For example, the vehicle information 214 may be stored in a non-volatile memory (not illustrated) of an ECU 300 in place of the non-volatile memory 202 of the relay ECU 200. In this case, the relay ECU 200 can obtain vehicle information from the ECU 300 through communication.

### 3. Hardware Configuration of Server

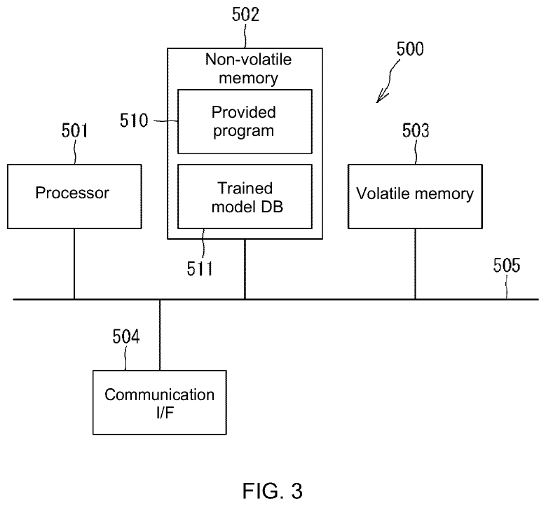

FIG. 3 is a block diagram showing an exemplary hardware configuration of a sever according to the present embodiment. The server 500 includes a processor 501, a non-volatile memory 502, a volatile memory 503, and a communication I/F 504. The processor 501, the non-volatile memory 502, the volatile memory 503, and the communication I/F 504 are connected to each other by a bus 505 that is a communication line. The processor 501, the non-volatile memory 502, the volatile memory 503, and the communication I/F 504 can transmit data to each other via the bus 505.

The volatile memory 503 is, for example, a semiconductor memory such as an SRAM or a DRAM. The non-volatile memory 502 is a flash memory, a hard disk, a ROM, or the like. The non-volatile memory 502 stores a provided program 510, which is a computer program, and data used for executing the provided program 510. The functions of the server 500 described later are performed by the provided program 510 being executed by the processor 501.

The processor 501 is, for example, a CPU. Note that the processor 501 is not limited to a CPU. The processor 501 may also be a GPU. In a specific example, the processor 501 is a multi-core processor. The processor 501 may also be a single-core processor. The processor 501 is configured to be capable of executing a computer program. Note that the processor 501 may be, for example, an ASIC, or may be a programmable logic device such as an FPGA. In this case, the ASIC or programmable logic device is configured to be capable of executing the same functions as the provided program 510.

The communication I/F 504 is, for example, an Ethernet interface (“Ethernet” is registered trademark). The communication I/F 504 is connected to the Internet, for example. The communication I/F 504 can transmit and receive TCP/IP packets, for example.

A trained model database 511 (hereinafter, also referred to as a “trained model DB 511”) is provided in the non-volatile memory 502. The trained model DB 511 stores a plurality of trained models. The trained model DB 511 is an example of a “storage unit”. The provided program 510 selects a trained model compatible with a vehicle from the trained model DB 511 in accordance with a request from the vehicle, and provides the selected trained model to the vehicle. The trained model DB 511 will be described later.

### 4. Trained Model

The trained model 212 is a computer program executable by the processor 201, and is used for detecting unauthorized frames.

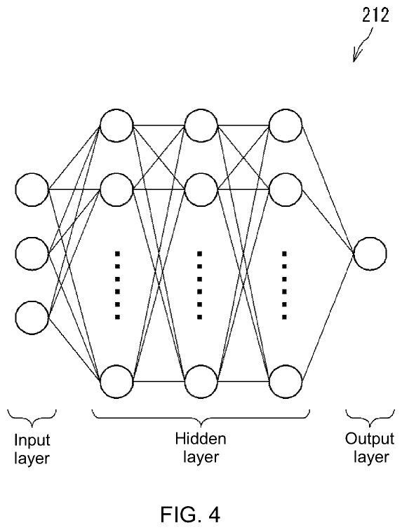

FIG. 4 is a schematic diagram showing an example of the configuration of a trained model according to the embodiment. The trained model 212 is constituted by a neural network, for example, and includes an input layer, a hidden layer, and an output layer.

The trained model 212 is constituted by a deep neural network, for example. The trained model 212 may be a convolutional neural network, a recurrent neural network, an LSTM (Long Short-Term Memory), or any other neural network.

The input layer accepts a vehicle value (first vehicle value) that was detected by a sensor and is included in a frame transmitted from an ECU 300. An input layer 212IN includes one or more nodes. For example, the input layer accepts first vehicle values, namely an engine speed, a throttle opening degree, and a gear position.

The hidden layer is composed of one or more processing layers. In the example shown in FIG. 4, the hidden layer has a three-layer structure. Each layer constituting the hidden layer has one or more nodes. The nodes of the input layer are respectively connected via edges of the nodes of the second layer via. A unique weight is set for each edge. The nodes of the second layer are connected via edges of the nodes of the third layer. The nodes of the third layer are connected via edges of the nodes of the fourth layer.

The output layer includes at least one node. The nodes of the fourth layer in the hidden layer are connected via edges of the node of the output layer.

The first vehicle values given to the respective nodes of the input layer are weighted by the weights of the edges and are passed to the nodes of the second layer. Each node of the second layer executes processing allocated thereto on the given data. The data processed by the nodes of the second layer is weighted by the weights of the corresponding edges and is passed to the nodes of the third layer. Each of the nodes of the third layer executes processing allocated thereto on the given data. In a similar manner, the data is sequentially passed to the fourth layer and then to the output layer. The data of the node included in the output layer is an estimated second vehicle value. A second vehicle value is a vehicle value correlated with one or more first vehicle values. For example, when the first vehicle values are an engine speed, a throttle opening degree, and a gear position, a second vehicle value is a vehicle speed.

For example, if a frame for transmitting a vehicle speed, which is a second vehicle value, is a legitimate frame (hereinafter, also referred to as an “authorized frame”), the vehicle speed included in the authorized frame takes a normal value indicating the actual vehicle speed. Therefore, if each of the engine speed, the throttle opening degree, and the gear position, which are input data, is normal, an estimated value of a vehicle speed output from the trained model 212 is a value close to a vehicle speed included in an authorized frame. For example, if a frame for transmitting a vehicle speed, which is a second vehicle value, is an unauthorized frame, the vehicle speed included in the unauthorized frame takes an abnormal value different from an actual vehicle speed. Therefore, an estimated value of a vehicle speed output from the trained model 212 is not similar to the vehicle speed included in the unauthorized frame.

The non-volatile memory 202 of the relay ECU 200 may store a plurality of trained models. For example, the non-volatile memory 202 may store trained models such as one that receives a depression amount of a brake pedal as input data and outputs an estimated value of an acceleration rate, and one that receives a rotation angle of a steering wheel as input data and outputs an estimated value of a steering angle of the wheel as output data.

### 5. Trained Model DB

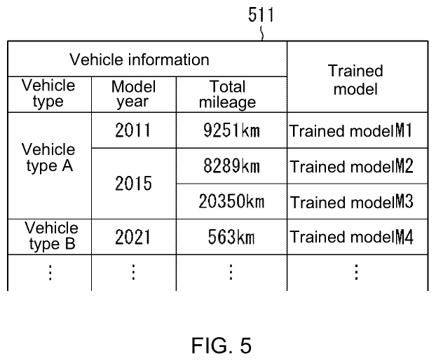

FIG. 5 is a diagram showing an example of the configuration of the trained model DB. The trained model DB 511 stores vehicle information and trained models in association. That is to say, the trained model DB 511 stores vehicle information and trained models compatible with vehicles specified by the vehicle information in association. Specifically, the vehicle information is vehicle information of vehicles for which corresponding trained models have been generated. In the example shown in FIG. 5, a trained model M1 is a trained model generated based on a vehicle of a vehicle type “vehicle type A”, a model year “2011”, and a total mileage of “9251 km”. A trained model M2 is a trained model generated based on a vehicle of a vehicle type “vehicle type A”, a model year “2015”, and a total mileage “8289 km”. A trained model M3 is a trained model generated based on a vehicle of a vehicle type “vehicle type A”, a model year “2015”, and a total mileage “20350 km”. A trained model M4 is a trained model generated based on a vehicle of a vehicle type “vehicle type B”, a model year “2021”, and a total mileage “563 km”.

### 6. Functions of Update System

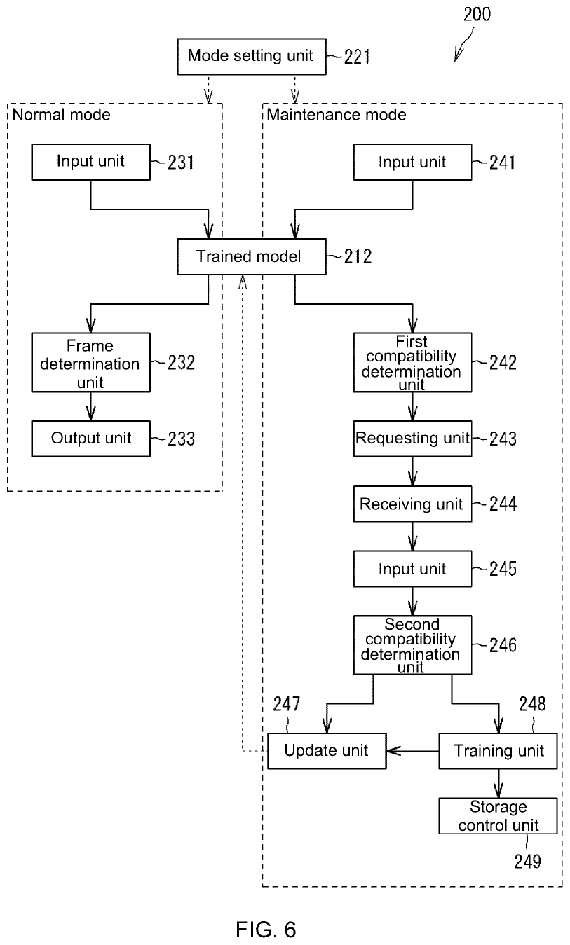

FIG. 6 is a functional block diagram showing exemplary functions of the relay ECU according to the embodiment.

By the processor 201 of the relay ECU 200 executing the unauthorized frame detection program 210 and the update program 211, functions of a mode setting unit 221, an input unit 231, a frame determination unit 232, an output unit 233, an input unit 241, a first compatibility determination unit 242, a requesting unit 243, a receiving unit 244, an input unit 245, a second compatibility determination unit 246, an update unit 247, a training unit 248, and a storage control unit 249 are realized.

The relay ECU 200 can be set to one of two operation modes, namely, a normal mode and a maintenance mode. The normal mode is an operation mode that is set when the vehicle is travelling. The maintenance mode is an operation mode that is set when a maintenance operation of the vehicle is performed. That is to say, the maintenance mode is an operation mode that is set when the vehicle is not travelling.

FIG. 1 is referenced. For example, maintenance operations including inspection and repair of the vehicle are performed at a dealer or the like. During a maintenance operation, an operator at the dealer connects the diagnostic apparatus 370 to the connector 410. When the diagnostic apparatus 370 is connected to the onboard system 100, a frame is transmitted from the diagnostic apparatus 370 to the onboard system 100. The relay ECU 200 detects connection to the diagnostic apparatus 370 by receiving the frame.

Returning to FIG. 6, for example, when connection to the diagnostic apparatus 370 is detected, the mode setting unit 221 switches the operation mode from the normal mode to the maintenance mode. When the diagnostic apparatus 370 is detached from the onboard system 100, the mode setting unit 221 switches the operation mode from the maintenance mode to the normal mode. That is to say, the normal mode is an operation mode that is set when the diagnostic apparatus 370 is not connected to the onboard system 100. The maintenance mode is an operation mode that is set when the diagnostic apparatus 370 is connected to the onboard system 100.

The input unit 231, the frame determination unit 232, and the output unit 233 are functions that are executed in the normal mode. The input unit 231, the frame determination unit 232, and the output unit 233 are realized by the unauthorized frame detection program 210.

The input unit 231 inputs first vehicle values to the trained model 212. In a specific example, the input unit 231 obtains first vehicle values from a frame received from the onboard network by the relay ECU 200, and inputs the obtained first vehicle values to the trained model 212. That is to say, the first vehicle values input to the trained model 212 by the input unit 231 are vehicle values most recently detected by the sensors 310A, 310B, and 310C, i.e., current values.

Upon accepting the first vehicle values as input data, the trained model 212 outputs an estimated second vehicle value. That is to say, output data from the trained model 212 is an estimated current second vehicle value obtained based on the current first vehicle values, and is an estimated value for a vehicle value most recently detected by the sensor 310D. The trained model 212 stored in the non-volatile memory 202 is an example of a “first trained model”.

The frame determination unit 232 compares the estimated value output from the trained model 212 with a second vehicle value transmitted over the onboard network, and determines whether or not the frame that includes the second vehicle value is an unauthorized frame. The frame determination unit 232 is an example of a “second determination unit”. In a specific example, the frame determination unit 232 obtains a current second vehicle value from a frame received from the onboard network by the relay ECU 200. The frame determination unit 232 compares the estimated value output from the trained model 212 with the current second vehicle value. For example, the frame determination unit 232 calculates the difference between the estimated value output from the trained model 212 and the current second vehicle value, and determines whether or not the difference is larger than or equal to a threshold. If the difference is smaller than the threshold, the frame determination unit 232 determines that the frame that includes the second vehicle value is an authorized frame. If the difference is larger than or equal to the threshold, the frame determination unit 232 determines that the frame that includes the second vehicle value is an unauthorized frame.

When the frame determination unit 232 detects an unauthorized frame, the output unit 233 outputs notification data for notifying the user of the detection of the unauthorized frame. For example, the output unit 233 generates a notification frame for notifying the user of the detection of the unauthorized frame and transmits the generated notification frame to the onboard network. For example, the onboard system is connected to a user interface device (hereinafter, also referred to as a “UI device”) (not illustrated). The UI device is an onboard apparatus mounted in the vehicle. The UI device is used by the driver of the vehicle. The UI device includes an input device and a display device, and is capable of accepting input from the driver and displaying information that is provided to the driver. The UI device receives the notification frame transmitted from the relay ECU 200 and displays a screen for performing notification of the detection of the unauthorized frame. Accordingly, the detection of the unauthorized frame is notified to the driver.

The input unit 241, the first compatibility determination unit 242, the requesting unit 243, the receiving unit 244, the input unit 245, the second compatibility determination unit 246, the update unit 247, the training unit 248, and the storage control unit 249 are functions that are executed in the maintenance mode. The input unit 231, the input unit 241, the first compatibility determination unit 242, the requesting unit 243, the receiving unit 244, the input unit 245, the second compatibility determination unit 246, the update unit 247, the training unit 248, and the storage control unit 249 are realized by the update program 211.

The input unit 241 inputs first vehicle values to the trained model 212. In a specific example, the input unit 241 reads out first vehicle values from the log data 213, and inputs the read first vehicle values to the trained model 212. That is to say, the first vehicle values that are input to the trained model 212 by the input unit 241 are vehicle values previously detected by the sensor 310A, 310B, and 310C, i.e., past values (actual values).

Upon accepting the first vehicle values that are input data, the trained model 212 outputs an estimated second vehicle value. That is to say, the output data from the trained model 212 is an estimated past second vehicle value obtained based on the past first vehicle values, and is an estimated value for a vehicle value previously detected by the sensor 310D.

The mechanical properties of a vehicle change due to deterioration over time. When the mechanical properties change, the correlation between first vehicle value and second vehicle value also changes. For this reason, there are cases where the trained model 212 that previously reflected the relationship between first vehicle value and second vehicle value correctly no longer reflects the relationship between first vehicle value and second vehicle value correctly due to deterioration of the vehicle over time.

The first compatibility determination unit 242 compares the estimated value output from the trained model 212 with a second vehicle value transmitted over the onboard network, and determines whether or not the trained model 212 is compatible with the vehicle. The first compatibility determination unit 242 is an example of a “first determination unit”. In a specific example, the first compatibility determination unit 242 reads out a second vehicle value from the log data 213. Second vehicle values recorded in the log data 213 are past second vehicle values. The first compatibility determination unit 242 compares the estimated value output from the trained model 212 with the second vehicle value read out from the log data 213. The second vehicle value used for comparison with the estimated value is the clock time when the first vehicle values input to the trained model 212 were detected, or a second vehicle value detected at a clock time close to the clock time when the first vehicle values were detected.

For example, the first compatibility determination unit 242 calculates the difference between an estimated value output from the trained model 212 and a past second vehicle value, and determines whether or not the difference is larger than or equal to a threshold. If the difference is smaller than the threshold, the first compatibility determination unit 242 determines that the trained model 212 is compatible with the vehicle. If the difference is larger than or equal to the threshold, the first compatibility determination unit 242 determines that the trained model 212 is not compatible with the vehicle.

If the first compatibility determination unit 242 determines that the trained model 212 is compatible with the vehicle, the trained model 212 is not updated, and is continuously used for detecting unauthorized frame.

The input/output relationship in the trained model 212 that is not compatible with the vehicle deviates from the actual correlation between first vehicle value and second vehicle value. For this reason, if the trained model 212 that is not compatible with the vehicle is used for detecting unauthorized frames, there is a risk that an unauthorized frame will be falsely detected or cannot be detected. Therefore, if the trained model 212 is not compatible with the vehicle, the trained model 212 needs to be updated to a trained model that correctly reflects the correlation between first vehicle value and second vehicle value.

If the first compatibility determination unit 242 determines that the trained model 212 is not compatible with the vehicle, the requesting unit 243 requests a new trained model from the server 500. In a specific example, the requesting unit 243 generates a request frame for requesting a new trained model and transmits the request frame to the onboard network.

The request frame includes vehicle information. That is to say, the requesting unit 243 reads out the vehicle information 214 from the non-volatile memory 202, and generates a request frame that includes the read vehicle information 214. The request frame transmitted by the requesting unit 243 is received by the external communication apparatus 350. Upon receiving the request frame, the external communication apparatus 350 performs necessary processing such as protocol conversion on the request frame, and transmits the processed request frame to the server 500.

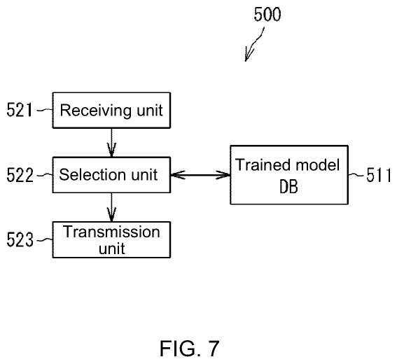

FIG. 7 is a functional block diagram showing exemplary functions of a server according to the embodiment.

Functions of a receiving unit 521, a selection unit 522, and a transmission unit 523 are realized by the processor 501 of the server 500 executing the provided program 510.

The receiving unit 521 receives a request frame transmitted from the vehicle.

When the receiving unit 521 receives the request frame, the selection unit 522 selects an updating trained model from the trained model DB 511.

In a specific example, the selection unit 522 selects an updating trained model from a plurality of trained models stored in the trained model DB 511 based on the vehicle information included in the request frame.

For example, the selection unit 522 can select a trained model corresponding to the same vehicle type as the vehicle type included in the request frame. It can be inferred that vehicles of the same vehicle type have similar mechanical properties. For this reason, it can be inferred that the relationship between first vehicle value and second vehicle value is similar between vehicles having the same vehicle type. Therefore, a trained model for a vehicle of the same vehicle type as the vehicle that has requested a trained model is considered to be likely to be compatible with the vehicle that has requested a trained model.

It is highly likely that the configuration of an onboard network differs between vehicles of different vehicle types. For example, there are cases where a vehicle value used in a first onboard network is not be used in a second onboard network. In contrast, the configuration of an onboard network is likely to be the same between vehicles of the same vehicle type. Also from this perspective, a trained model for a vehicle of the same vehicle type as the vehicle that has requested a trained model is considered to be likely to be compatible with the vehicle that has requested a trained model.

For example, the selection unit 522 can select a trained model corresponding to a model year close to the model year included in the request frame. It can be inferred that vehicles whose model years are similar have deteriorated over time to similar extents. For this reason, the relationship between first vehicle value and second vehicle value is inferred to be similar between vehicles whose model years are similar. Therefore, a trained model for a vehicle whose model year is similar to the model year of the vehicle that has requested a trained model is considered to be likely to be compatible with the vehicle that has requested a trained model.

For example, in a case where a plurality of trained models corresponding to the same vehicle type as the vehicle type included in the request frame are stored in the trained model DB 511, the selection unit 522 can select a trained model corresponding to a model year closest to the model year included in the request frame.

For example, the selection unit 522 can select a trained model corresponding to a total mileage close to the total mileage included in the request frame. It can be inferred that vehicles whose total mileages are similar have deteriorated to similar extents. For this reason, the relationship between first vehicle value and second vehicle value is estimated to be similar between vehicles whose total mileages are similar. Therefore, a trained model for a vehicle whose total mileage is similar to the total mileage of the vehicle that has requested a trained model is considered to be likely to be compatible with the vehicle that has requested a trained model.

For example, the selection unit 522 can select a trained model corresponding to the vehicle type and the model year included in the vehicle information. If there are a plurality of trained models corresponding to the vehicle type and the model year included in the vehicle information, the selection unit 522 can select one of the plurality of trained models based on the total mileage included in the vehicle information. In a specific example, in a case where a plurality of trained models corresponding to the same vehicle type and model year as the vehicle type and the model year included in the request frame are stored in the trained model DB 511, the selection unit 522 can select a trained model corresponding to a total mileage closest to the total mileage included in the request frame.

The transmission unit 523 transmits the updating trained model selected by the selection unit 522 to the vehicle that has made the request.

Reference returns to FIG. 6. The trained model transmitted from the server 500 is received by the external communication apparatus 350. The external communication apparatus 350 divides the received trained model into a plurality of frames, for example, and transmits the frames to the relay ECU 200. The receiving unit 244 receives frames transmitted from the external communication apparatus 350, that is, an updating trained model.

The input unit 245 inputs first vehicle values to the received updating trained model (hereinafter, also referred to as an “updating model”). An updating model is an example of a “second trained model”. In a specific example, the input unit 231 reads out first vehicle values from the log data 213, and inputs the read first vehicle values to the updating model. That is to say, the first vehicle values that are input to the updating model by the input unit 231 are vehicle values previously detected by the sensors 310A, 310B, and 310C, i.e., past values (actual values).

Upon accepting the first vehicle values that are input data, the updating model outputs an estimated second vehicle value. That is to say, the output data from the updating model is an estimated past second vehicle value obtained based on the past first vehicle values, and is an estimated value for a vehicle value previously detected by the sensor 310D.

The second compatibility determination unit 246 compares the estimated value output from the updating model with a second vehicle value transmitted over the onboard network, and determines whether or not the updating model is compatible with the vehicle. The second compatibility determination unit 246 is an example of a “third determination unit”. In a specific example, the second compatibility determination unit 246 reads out a second vehicle value from the log data 213. The second vehicle value recorded in the log data 213 is a past second vehicle value. The second compatibility determination unit 246 compares the estimated value output from the updating model with the second vehicle value read out from the log data 213. The second vehicle value that is compared with the estimated value is the clock time when the first vehicle values input to the updating model were detected, or a second vehicle value detected at a clock time close to the clock time when the first vehicle values were detected.

For example, the second compatibility determination unit 246 calculates the difference between the estimated value output from the updating model and the past second vehicle value, and determines whether or not the difference is larger than or equal to a threshold. If the difference is smaller than the threshold, the second compatibility determination unit 246 determines that the updating model is compatible with the vehicle. If the difference is larger than or equal to the threshold, the second compatibility determination unit 246 determines that the updating model is not compatible with the vehicle.

If the second compatibility determination unit 246 determines that the updating model is compatible with the vehicle, the update unit 247 updates the trained model 212 stored in the non-volatile memory 202 to the updating model. That is to say, the update unit 247 overwrites the trained model 212 stored in the non-volatile memory 202 with the updating model.

If the second compatibility determination unit 246 determines that the updating model is not compatible with the vehicle, the training unit 248 generates a new trained model (hereinafter, also referred to as a “new model”) by executing supervised learning using first and second vehicle values transmitted over the onboard network as training data. The new model is an example of a “third trained model”.

In a specific example, the training unit 248 reads out first vehicle values and second vehicle values from the log data 213, and creates training data from the read first and second vehicle values. For example, the log data 213 includes a sufficient amount of data of first and second vehicle values required for supervised learning. Specifically, the log data 213 stores first and second vehicle values that have been detected over a certain period of time. For example, when the relay ECU 200 receives new first and second vehicle values, the received new first and second vehicle values are added to the log data 213. For example, when new first and second vehicle values are added to the log data 213, the oldest first and second vehicle values may be removed from the log data 213. For example, the training unit 248 can create training data using all of the first and second vehicle values included in the log data 213.

The training unit 248 generates, based on the training data, a trained model that receives, as input, first vehicle values and outputs a second vehicle value. That is to say, the training unit 248 executes machine learning using training data, and constructs a learning model.

The training unit 248 provides the training data to a neural network, and executes supervised learning. In supervised learning, training is performed such that first vehicle values in the training data are provided to the neural network as input, and a value matching the corresponding second vehicle value is output from the neural network. Such machine learning is repeatedly performed using a plurality of datasets, each dataset being a combination of first vehicle values and a second vehicle value. In the machine learning, existing learning algorithms such as backpropagation and the gradient descent method may be used. Through the machine learning, the weights of the neural network are adjusted, and a trained model is constructed.

The update unit 247 can update the trained model 212 stored in the non-volatile memory 202 to the new model generated by the training unit 248.

The storage control unit 249 stores the new model generated by the training unit 248, in the trained model DB 511. In a specific example, the storage control unit 249 transmits a registration request that includes the new model generated by the training unit 248 and the vehicle information 214. The registration request is, for example, divided into a plurality of frames, which are then transmitted to the external communication apparatus 350. Upon receiving the registration request, the external communication apparatus 350 performs necessary processing such as protocol conversion, and transmits the processed registration request to the server 500.

Upon receiving the registration request, the server 500 registers, in the trained model 511, the vehicle information and the new model included in the registration request. Accordingly, the new model can be then used for a plurality of vehicles.

### 7. Operations of Update System

Operations of an onboard system according to the present embodiment will be described below.

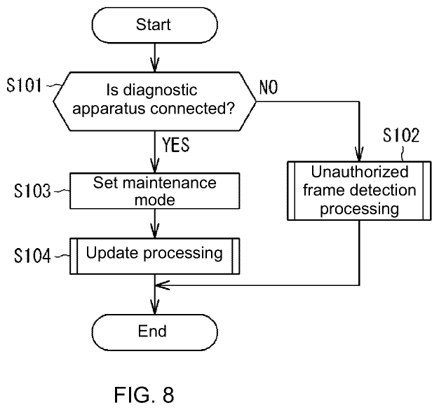

FIG. 8 is a flowchart showing exemplary operations of a relay ECU according to the embodiment.

The default operation mode of the relay ECU 200 is the normal mode. That is to say, the relay ECU 200 is set to the normal mode at the time of startup.

When the diagnostic apparatus 370 is connected to the onboard network, the diagnostic apparatus 370 transmits a frame. The processor 201 of the relay ECU 200 detects the connection to the diagnostic apparatus 370 by receiving the frame. The processor 201 determines whether or not the diagnostic apparatus 370 is connected to the onboard network (step S101).

If the diagnostic apparatus 370 is not connected to the onboard network (NO in step S101), the processor 201 maintains the normal mode, and executes unauthorized frame detection processing (step S102).

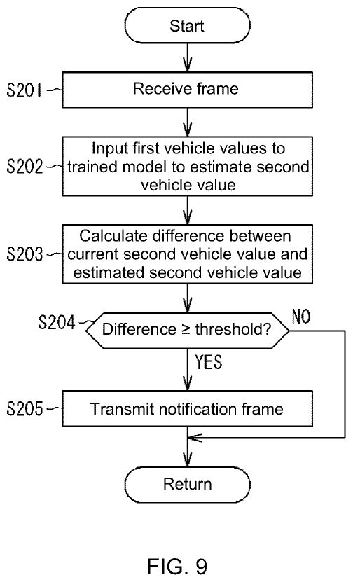

FIG. 9 is a flowchart showing an example of the unauthorized frame detection processing.

In the unauthorized frame detection processing, the processor 201 receives a frame that includes first vehicle values and a frame that includes a second vehicle value (step S201). For example, in a case of CAN, a CAN ID indicating a source ECU 300 that has transmitted a frame is allocated to the frame. The processor 201 specifies the source ECU 300 that has transmitted the frame using the CAN ID of the frame, and can thereby determine whether the frame is a frame that includes first vehicle values, a frame that includes a second vehicle value, or a frame other than them.

The processor 201 obtains first vehicle values from the received frame, and inputs the obtained first vehicle values to the trained model 212. The trained model 212 outputs an estimated second vehicle value (step S202).

The processor 201 obtains a current second vehicle value from the frame received in step S201, and calculates the difference between the obtained current second vehicle value and the estimated second vehicle value (step S203).

The processor 201 compares the calculated difference with a threshold (step S204). If the difference is smaller than the threshold (NO in step S204), the processor 201 ends the unauthorized frame detection processing.

If the difference is larger than or equal to the threshold (YES in step S204),
the processor 201 determines that the received frame is an unauthorized frame, and transmits a notification frame for notifying the user of the detection of the unauthorized frame (step S205). The UI device receives the notification frame and displays a screen for performing notification of the detection of the unauthorized frame. The unauthorized frame detection processing then ends.

Returning to FIG. 8, when the unauthorized frame detection processing ends, the operations of the relay ECU 200 end. The relay ECU 200 repeatedly executes the operations shown in FIG. 8 in a predetermined cycle, for example.

If the diagnostic apparatus 370 is connected to the onboard network (YES in step S101), the processor 201 sets the operation mode to the maintenance mode (step S103).

The processor 201 executes update processing (step S104).

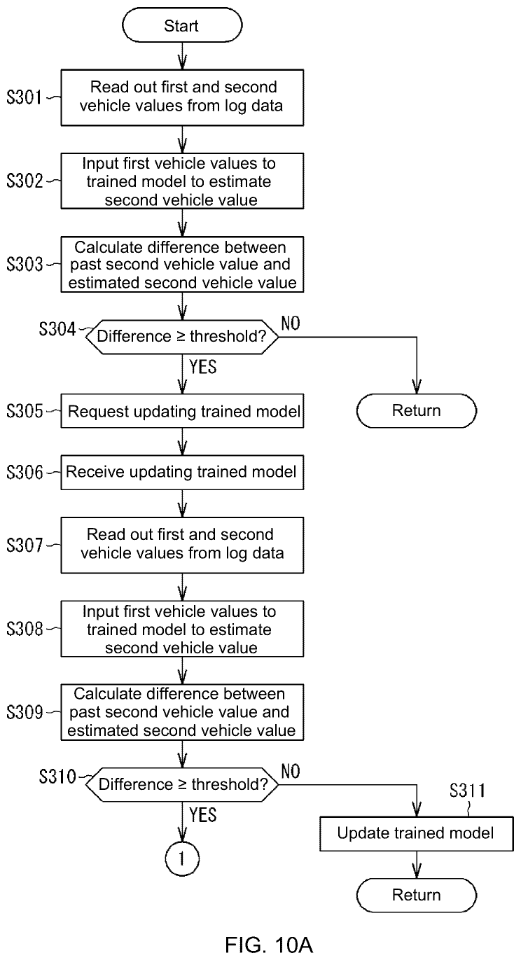

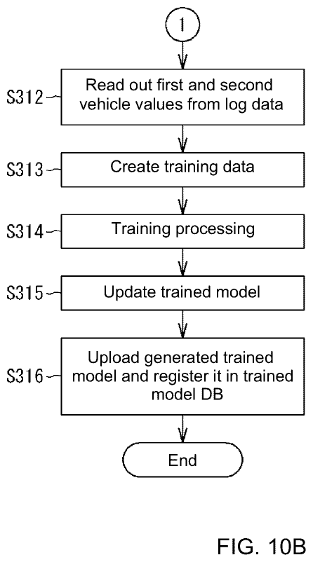

FIGS. 10A and 10B are flowcharts showing an example of the update processing.

Referencing FIG. 10A, in the update processing, the processor 201 reads out past first and second vehicle values from the log data 213 (step S301).

The processor 201 inputs the first vehicle values read out from the log data 213 to the trained model 212. The trained model 212 outputs an estimated second vehicle value (step S302).

The processor 201 calculates the difference between the past second vehicle value read out from the log data 213 and the estimated second vehicle value (step S303).

The processor 201 compares the calculated difference with a threshold (step S304). If the difference is smaller than the threshold (NO in step S304), the processor 201 determines that the trained model 212 is compatible with the vehicle, and ends the update processing.

If the difference is larger than or equal to the threshold (YES in step S304), the processor 201 determines that the trained model 212 is not compatible with the vehicle. The processor 201 transmits a request frame for requesting an updating model from the server 500. The request frame includes the vehicle information 214. The request frame is received by the external communication apparatus 350, and transferred to the server 500 by the external communication apparatus 350.

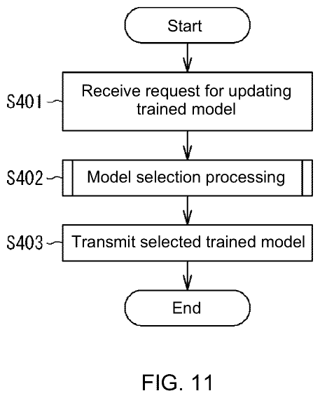

FIG. 11 is a flowchart showing exemplary operations of the server according to the embodiment.

The server 500 receives the request frame (step S401). Accordingly, the processor 501 of the server 500 accepts the request for an updating model.

The processor 501 executes model selection processing for selecting an updating model from the trained model DB 511 based on the vehicle information included in the request frame (step S402).

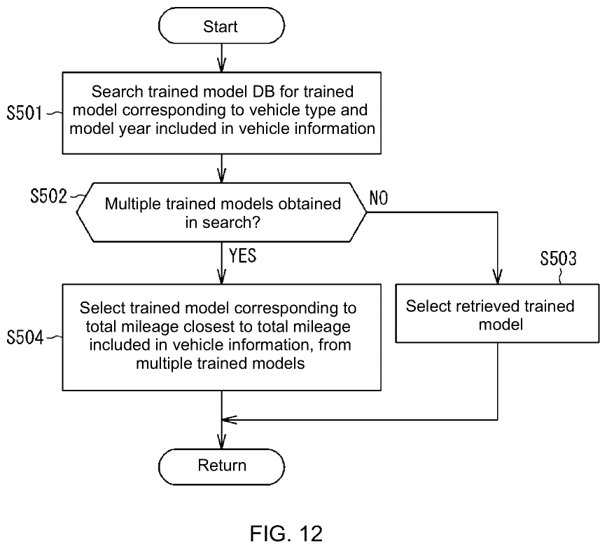

FIG. 12 is a flowchart showing an example of the model selection processing.

In the model selection processing, the processor 501 searches the trained model DB 511 for a trained model corresponding to the vehicle type and the model year included in the vehicle information (step S501).

The processor 501 determines whether or not a plurality of trained models corresponding to the vehicle type and the model year included in the vehicle information are obtained as a search result (step S502). If only one trained model corresponding to the vehicle type and the model year included in the vehicle information is obtained (NO in step S502), the processor 501 selects the trained model as an updating model (step S503).

If a plurality of trained models corresponding to the vehicle type and the model year included in the vehicle information are obtained (YES in step S502), the processor 501 selects, as an updating model, a trained model corresponding to a total mileage closest to the total mileage included in the vehicle information, from these trained models (step S504). The model selection processing then ends.

Returning to FIG. 11, the processor 501 transmits the selected updating model to the vehicle that has made the request (the external communication apparatus 350) (step S403). The operations of the server 500 then end.

Reference returns to FIG. 10A. Upon receiving the updating model transmitted from the server 500, the external communication apparatus 350 performs necessary processing such as protocol conversion, and transmits the processed updating model to the relay ECU 200. The relay ECU 200 receives the updating model (step S306).

The processor 201 reads out past first and second vehicle values from the log data 213 (step S307).

The processor 201 inputs the first vehicle values read out from the log data 213 to the updating model. The updating model outputs an estimated second vehicle value (step S308).

The processor 201 calculates the difference between a past second vehicle value read out from the log data 213 and the estimated second vehicle value output from the updating model (step S309).

The processor 201 compares the calculated difference with a threshold (step S310). If the difference is smaller than the threshold (NO in step S310), the processor 201 determines that the updating model is compatible with the vehicle, and updates the trained model 212 stored in the non-volatile memory 202 to the updating model (step S311).

If the difference is larger than or equal to the threshold (YES in step S310), the processor 201 determines that the updating model is not compatible with the vehicle.

With reference to FIG. 10B, the processor 201 reads out past first and second vehicle values from the log data 213 (step S312). The processor 201 creates training data based on the read first and second vehicle values (step S313).

The processor 201 provides the training data to a neural network, and executes training processing (step S314). Accordingly, a new model is generated.

The processor 201 updates the trained model 212 stored in the non-volatile memory 202 to the new model (step S315).

The processor 201 transmits a registration request that includes the generated new model and the vehicle information. The registration request is transmitted (uploaded) to the server 500 by the external communication apparatus 350. Upon receiving the registration request, the server 500 registers the vehicle information and the new model included in the registration request, in the trained model DB 511. The update processing then ends.

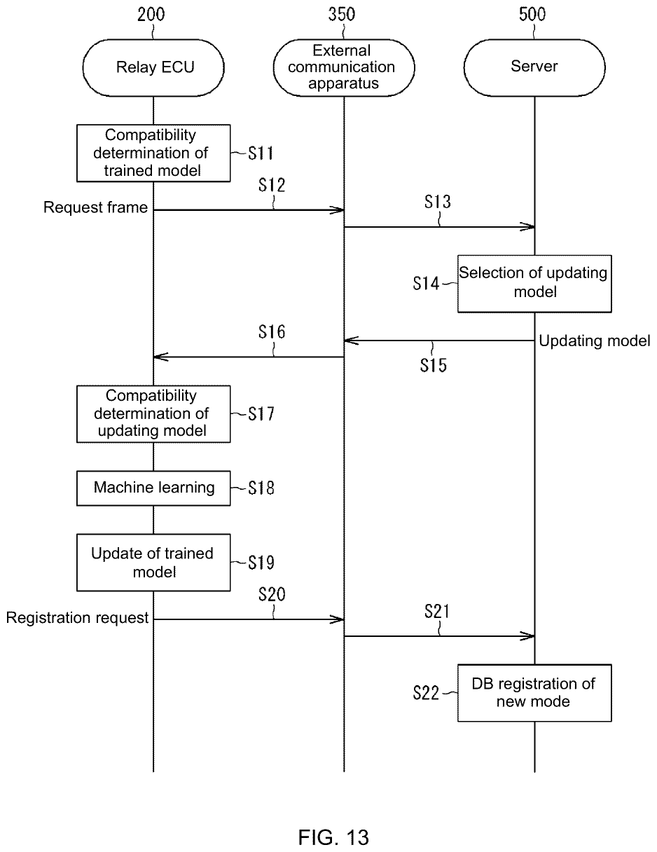

FIG. 13 is a flowchart showing exemplary operations of the update system according to the embodiment. FIG. 13 shows operations of the update system when the operation mode of the relay ECU 200 is the maintenance mode.

When the diagnostic apparatus 370 is connected to the onboard network, the processor 201 of the relay ECU 200 sets the operation mode to the maintenance mode. The processor 201 executes update processing.

The processor 201 inputs first vehicle values included in the log data 213 to the trained model 212. The processor 201 obtains an estimated value output from the trained model 212. The processor 201 compares a second vehicle value included in the log data 213 with the estimated value output from the trained model 212, and determines whether or not the trained model 212 is compatible with the vehicle (step S11).

If it is determined that the trained model 212 is compatible with the vehicle, the processor 201 ends the processing. In this case, the trained model 212 is not updated.

If it is determined that the trained model 212 is not compatible with the vehicle, the processor 201 reads out the vehicle information 214 from the non-volatile memory 202, and transmits a request frame that includes the vehicle information 214 (step S12). The external communication apparatus 350 receives the request frame, performs necessary processing such as protocol conversion on the received request frame, and then transmits the processed frame to the server 500 (step S13).

When the server 500 receives the request frame, the processor 501 selects an updating trained model from the trained model DB 511 based on the vehicle information included in the request frame (step S14).

The processor 501 transmits an updating model that is the selected trained model (step S15). The external communication apparatus 350 receives the updating model, performs necessary processing such as protocol conversion on the received updating model, and then transmits the processed updating model to the relay ECU 200 (step S16).

The relay ECU 200 receives the updating model. The processor 201 inputs first vehicle values included in the log data 213 to the updating model. The processor 201 obtains an estimated value output from the updating model. The processor 201 compares a second vehicle value included in the log data 213 with the estimated value output from the updating model, and determines whether or not the updating model is compatible with the vehicle (step S17).

If it is determined that the updating model is compatible with the vehicle, the processor 201 updates the trained model 212 using the updating model.

If it is determined that the updating model is not compatible with the vehicle, the processor 201 creates training data based on the log data 213, and performs machine learning using the created training data (step S18). The processor 201 updates the trained model 212 using a new model, which is the trained model generated through machine learning (step S19). Note that FIG. 13 shows exemplary operations of the update system when the updating model is not compatible with the vehicle.

The processor 201 transmits a registration request that includes the generated new model and the vehicle information 214 (step S20). The external communication apparatus 350 receives the registration request, performs necessary processing such as protocol conversion on the received registration request, and then transmits the processed registration request to the server 500 (step S21).

When the server 500 receives the registration request, the processor 501 registers the vehicle information 214 and the new model included in the registration request, in the trained model DB 511 (step S22).

### 8. Modified Example

In the above embodiment, the trained model DB 511 is provided in the server 500, but there is no limitation thereto. For example, a database server that includes the same database as the trained model DB 511 may be provided separately from the server 500. In this case, for example, the server 500 may access the database server and select an updating model compatible with the vehicle information.

In the above embodiment, a plurality of trained models are stored in the trained model DB 511, but there is no limitation thereto. For example, a plurality of trained models may be stored in a file system. In this case, the server 500 can store a table that stores storage locations (directories) of the trained models in association with vehicle information, and specify the storage location of a trained model compatible with vehicle information by referring to the table. The server 500 can obtain a trained model from the specified storage location, and download the obtained trained model to the vehicle. In another example, the server 500 can transmit a storage location of a trained model to the external communication apparatus 350 as a response to a request. The external communication apparatus 350 can download the trained model from the received storage location, for example, through FTP (File Transfer Protocol), and transfer the downloaded trained model to the relay ECU 200.

In the above embodiment, an updating trained model is selected based on the vehicle type, the model year, and the total mileage of the vehicle, but there is no limitation thereto. In addition to the above vehicle information or in place of at least one piece of the information, an updating trained model may be selected based on the country or region in which the vehicle is registered. Climate varies depending on the country or region, and the rate of vehicle deterioration differs depending on the climate. Therefore, a trained model corresponding to the same country or region as the vehicle that has made the request is considered to be likely to be compatible with the vehicle that has made the request.

In the above embodiment, the trained model 212 is a neural network, but there is no limitation thereto. A trained model generated using a supervised machine learning algorithm other than neural networks such as a decision tree and a support vector machine may also be used.

In the above embodiment, a configuration is adopted in which the relay ECU 200 stores the trained model 212 and determines whether or not the trained model 212 is compatible with the vehicle, but there is no limitation thereto. An ECU 300 may store the trained model 212 and determine whether or not the trained model 212 is compatible with the vehicle.

### SUPPLEMENTARY NOTES

### Supplementary Note 1

A method for updating a trained model used for detecting an unauthorized frame in an onboard apparatus, the method comprising: a step of inputting, by the onboard apparatus, a first vehicle value to a first trained model configured to receive, as input data, the first vehicle value transmitted over an onboard network connected to the onboard apparatus, and output an estimated value correlated with the first vehicle value, and outputting the estimated value output from the first trained model: a step of comparing, by the onboard apparatus, the obtained estimated value with a second vehicle value transmitted over the onboard network, and determining whether or not the first trained model is compatible with a vehicle; a step of selecting, by a server, a second trained model for updating the first trained model if it is determined that the first trained model is not compatible with the vehicle; a step of transmitting, by the server, the selected second trained model to the onboard apparatus; a step of receiving, by the onboard apparatus, the second trained model transmitted from the server; and a step of updating, by the onboard apparatus, the first trained model to the received second trained model.

### Supplementary Note 2

A method for updating, by an onboard apparatus connected to an onboard network, a trained model used for detecting an unauthorized frame, in the onboard apparatus, the method comprising: a step of inputting, by the onboard apparatus, a first vehicle value to a first trained model configured to receive, as input data, the first vehicle value transmitted over the onboard network and output an estimated value correlated with the first vehicle value, and obtaining the estimated value output from the first trained model; a step of comparing the estimated value output from the first trained model with a second vehicle value transmitted over the onboard network, and determining whether or not the first trained model is compatible with a vehicle; a step of receiving a second trained model for updating the first trained model from a server if it is determined that the first trained model is not compatible with the vehicle; and a step of updating the first trained model to the received second trained model.

### Supplementary Note 3

An update program for updating a trained model used for detecting an unauthorized frame in an onboard apparatus connected to an onboard network, the update program causing a computer to execute: a step of inputting a first vehicle value to a first trained model configured to receive, as input data, the first vehicle value transmitted over the onboard network and output an estimated value correlated with the first vehicle value, and obtaining the estimated value output from the first trained model; a step of comparing the estimated value output from the first trained model with a second vehicle value transmitted over the onboard network, and determining whether or not the first trained model is compatible with a vehicle; a step of receiving a second trained model for updating the first trained model from a server if it is determined that the first trained model is not compatible with the vehicle; and a step of updating the first trained model to the received second trained model.

### Supplementary Note 4

A providing method for providing a trained model used for detecting an unauthorized frame to an onboard apparatus connected to an onboard network, the providing method comprising: a step of selecting a second trained model for updating a first trained model configured to receive, as input data, a first vehicle value transmitted over the onboard network and output an estimated value correlated with the first vehicle value, with a second vehicle value transmitted over the onboard network if it is determined that the first trained model is not compatible with a vehicle; and a step of transmitting the selected second trained model to the onboard apparatus.

### Supplementary Note 5

A provided program for providing a trained model used for detecting an unauthorized frame in an onboard apparatus connected to an onboard network, to the onboard apparatus, the method causing a computer to execute: a step of selecting a second trained model for updating a first trained model configured to receive, as input data, a first vehicle value transmitted over the onboard network and output an estimated value corelated with the first vehicle value, if it is determined that the first trained model is not compatible with a vehicle by comparing the estimated value output from the first trained model with a second vehicle value transmitted over the onboard network; and a step of transmitting the selected second trained model to the onboard apparatus.

### APPENDIX

The embodiments disclosed herein are examples in all respects and are not limiting in any manner. The scope of the present disclosure is defined not by the above embodiments, but is defined by the claims and intended to include all modifications within the meaning and scope equivalent to the claims.

1. An update system comprising:
an onboard apparatus; and
a server,
wherein the onboard apparatus includes:
a first trained model configured to receive, as input data, a first vehicle value transmitted over an onboard network to which the onboard apparatus is to be connected, and output an estimated value correlated with the first vehicle value; and
a first determination unit configured to compare the estimated value output from the first trained model with a second vehicle value transmitted over the onboard network, and determine whether or not the first trained model is compatible with a vehicle,
the server includes:
a selection unit configured to select a second trained model for updating the first trained model if the first determination unit determines that the first trained model is not compatible with the vehicle; and
a transmission unit configured to transmit the second trained model selected by the selection unit to the onboard apparatus, and
the onboard apparatus includes:
a receiving unit configured to receive the second trained model transmitted from the server; and
an update unit configured to update the first trained model to the second trained model received by the receiving unit.

2. The update system according to claim 1,
wherein the onboard apparatus further includes a storage unit configured to store first and second vehicle values previously transmitted over the onboard network, and
the first determination unit compares the estimated value output from the first trained model as a result of inputting the first vehicle value stored in the storage unit to the first trained model, with the second vehicle value stored in the storage unit, and determine whether or not the first trained model is compatible with the vehicle.

3. The update system according to claim 2, wherein the first determination unit determines whether or not the first trained model is compatible with the vehicle while the vehicle is in a stopped state.

4. The update system according to claim 2,
wherein the onboard apparatus further includes
a mode setting unit configured to set an operation mode to either a normal mode in which the vehicle travels or a maintenance mode for performing maintenance on the vehicle, and
the first determination unit determines whether or not the first trained model is compatible with the vehicle when the operation mode is the maintenance mode.

5. The update system according to claim 4, wherein the onboard apparatus further includes a second determination unit configured to, when the operation mode is the normal mode, compare the estimated value output from the first trained model with a second vehicle value transmitted over the onboard network, and determine whether or not a frame that includes the second vehicle value is an unauthorized frame.

6. The update system according to claim 1, wherein the selection unit selects the second trained model based on vehicle information related to the vehicle.

7. The update system according to claim 6, wherein the vehicle information includes a vehicle type of the vehicle.

8. The update system according to claim 6, wherein the vehicle information includes a model year of the vehicle.

9. The update system according to claim 6, wherein the vehicle information includes a total mileage of the vehicle.

10. The update system according to claim 6,
wherein the vehicle information includes a vehicle type, a model year, and a total mileage of the vehicle,
the selection unit selects the second trained model corresponding to the vehicle type and the model year included in the vehicle information, and
when a plurality of second trained models corresponding to the vehicle type and the model year included in the vehicle information are present, the selection unit selects one of the plurality of second trained models based on the total mileage included in the vehicle information.

11. The update system according to claim 1, wherein the selection unit selects the second trained model from a storage unit that stores a plurality of trained models.

12. The update system according to claim 1,
wherein the onboard apparatus further includes:
a third determination unit configured to compare an estimated value output from the second trained model with a second vehicle value transmitted over the onboard network, and determine whether or not the second trained model is compatible with the vehicle, and
a training unit configured to generate a third trained model by executing supervised learning using the first and second vehicle values transmitted over the onboard network as training data if the third determination unit determines that the second trained model is not compatible with the vehicle, and
the update unit updates the first trained model to the third trained model generated by the training unit.

13. The update system according to claim 12, wherein the onboard apparatus further includes a storage control unit configured to store the third trained model generated by the training unit, in a storage unit that stores a plurality of trained models usable for a plurality of vehicles.

14. The update system according to claim 1, wherein the onboard apparatus is a relay apparatus that is to be connected to a plurality of communication lines included in the onboard network, and is configured to relay a frame between a plurality of onboard apparatuses.

15. An onboard apparatus to be connected to an onboard network, the onboard apparatus comprising:
a first trained model configured to receive, as input data, a first vehicle value transmitted over the onboard network and output an estimated value correlated with the first vehicle value;
a first determination unit configured to compare the estimated value output from the first trained model with a second vehicle value transmitted over the onboard network, and determine whether or not the first trained model is compatible with a vehicle;
a receiving unit configured to receive a second trained model for updating the first trained model from a server if the first determination unit determines that the first trained model is not compatible with the vehicle; and
an update unit configured to update the first trained model to the second trained model received by the receiving unit.

16. A server capable of communicating with an onboard apparatus, the server comprising:
a selection unit configured to compare an estimated value output from a first trained model configured to receive, as input data, a first vehicle value transmitted over an onboard network to which the onboard apparatus is to be connected and output an estimated value corelated with the first vehicle value, with a second vehicle value transmitted over the onboard network, and select a second trained model for updating the first trained model, if the first trained model is determined to be not compatible with a vehicle; and
a transmission unit configured to transmit the second trained model selected by the selection unit to the onboard apparatus.
